(19) United States
(12) Patent Application Publication
(10) Pub. No.: US 2017/0303549 A1
(43) Pub. Date: Oct. 26, 2017

(54) PROCESS, PRODUCT AND METHOD

(71) Applicant: NESTEC S.A., Vevey (CH)

(72) Inventors: Rodolfo De Acutis, York Yorkshire (GB); Madian Othman Abu-Hardan, York Yorkshire (GB); Wei Lu, York Yorkshire (GB)

(21) Appl. No.: 15/517,263

(22) PCT Filed: Oct. 5, 2015
(86) PCT No.: PCT/EP2015/072964

§ 371 Date: Apr. 6, 2017

(30) Foreign Application Priority Data
Oct. 6, 2014 (EP) 14187720.9

(51) Int. Cl. A21D 8/04; A21D 10/04; A21D 13/45

(52) U.S. Cl. CPC A21D 8/042; A21D 13/45; A21D 10/04

(57) ABSTRACT

The present invention relates to the production of edible wafers with a high fat content by an industrial process, which wafer is produced from a batter comprising: (i) at least parts by weight of fat; (ii) at least 40 by weight % of a hard flour or at least 50 parts by weight % of a soft flour (or if a mixture of hard and soft proportionate minimum amounts), and (iii) an amount of water so the weight ratio of total amount of water to total amount of flour in the batter (denoted herein as R[w/f]) is no more than 1.5; (iv) at least one enzyme comprising a cellulase in an amount of at least 0.0001 parts by weight; and the batter has a viscosity of from 200 to 1900 cps so it can be both pumped and baked on a heated surface without spillage.

The present invention relates to a method and apparatus for making a baked foodstuff such as a wafer and to a method for making a batter.

In International Journal of Food Science and Technology 41, p. 569-576 (2006), Ismail S. Dogan defines a wafer as low-moisture-baked foods being formed from a batter and baked between hot plates. It is further disclosed that the quality of wafer sheets is mainly controlled by flour property, water level and temperature, mixing action, baking time and temperature. The quality of the wafer is a result of attributes of the batter such as the density, viscosity, holding time and temperature, and by properties of the wafer such as weight, surface colour, fragility and moisture content. The study concludes that wafers have little in common with other types of biscuits in regard to the formulae and processing, and that water level and gluten content are important for obtaining a high-quality wafer sheet.

Manufacturing wafers consists in preparing a batter containing mainly flour and water to which other minor ingredients may be added. Typically 40 to 50% flour in batter is used in the manufacture of commercial flat wafers. In the wafer manufacture, after preparation the batter is usually cooked between two heated engraved metal plates for a determined time at a certain temperature, for instance 2 min at 160° C., to produce large flat wafer sheets with a low moisture level. After cooling, the wafers are processed according to the requirements of the final product.

Wafers are baked products which are made from wafer batter and have crisp, brittle and fragile consistency. They are thin, with an overall thickness usually between 1 and 4 mm and typical product densities range from 0.1 to 0.3 g/cm³. The surfaces are precisely formed, following the surface shape of the plates between which they were baked. They often carry a pattern on one surface or on both. Manufacturing wafers consists in preparing a batter containing mainly flour and water to which other minor ingredients may be added.

When preparing a baked foodstuff such as a wafer, on an industrial scale, there is a need to have sufficiently low viscosity for the batter to be processed. For example in a conventional production line wafer batter will need to be pumped to the stations where it is needed. This limits the type of flours that can be used to those soft flours that form a flowable batter rather than hard flours than form a sticky dough. The terms ‘hard flour’ and ‘soft flours’ are defined later in this document.

The viscosity of the batter can be lowered by added more water to the batter mix, however there is a limit to how much this can be done as then it is more difficult to control the process and bake wafers of consistent quality. Another added complication is that, if more water is added to the batter, then the viscosity of the batter decreases and it becomes difficult to handle and deposit a low viscosity liquid onto the baking plates. Unwanted dripping of the batter will occur at the point of deposition causing waste and oven fires. Batter may flow on the plate to too great an extent causing defects such as holes in the resultant baked product. Lower viscosity batter also results in a lower density in the baked product which can lead to an excessively fragile product with an increased tendency to break on release from the plate.

Thus for a batter used to make baked foodstuffs there exists a narrow viscosity window within which it can be processed on an industrial scale to make consistent high quality baked products. Batters with too high or too low a viscosity will not be suitable and this limits the type of flours that can be used or the amount of water that can be added. This window can conveniently be defined by a water to flour ratio (w/f). A conventional wafer recipe comprises by weight: 100 to 160 parts of water to 100 parts of flour and thus has a water to flour ratio (w/f) from 1 to 1.6, which is the range of w/f that will create a batter with an acceptable viscosity.

To create baked foodstuffs with different tastes it is desirable to add an increased amount of fat to the batter to follow different recipes. Typical wafer recipes have no more than about 2% fat by weight. However to add sufficient fat to create a noticeable effect on the taste requires an much larger amount (from 5% up to 20% by weight) and batters with such high a proportion of fat also will have an unacceptably low viscosity to prepare a wafer. This is undesirable for the reasons explained above. Also as explained above whilst adding more flour or using hard flour might reduce the batter flow of a high fat content recipe to acceptable levels the resultant mixture then forms dough which can be processed. Thus it has not been possible to make wafers with high fat recipes from a batter that can be processed on an industrial scale.

Thus it has not been possible to make wafers from substantial quantities of fat without encountering some or all of the problems identified herein.

It would thus be desirable to provide a process for preparing baked foodstuff such as a wafer that addressed some or all of the problems described herein and also to provide baked foodstuffs having beneficial properties as described herein.

Cellulase and hemicellulase denotes enzymes (such as xylanase, pentonase and galactanase) that hydrolyse cellulose and/or hemicellulose. These materials comprise polysaccharides (such as xylan, arabinoxylan, xyloglucan and glucomannan) that may be obtained by alkaline extraction from plant tissues. The use of cellulases and hemi-cellulases in baking is known. Such enzymes are available commercially from DSM under the registered trade marks BakeZyme®. Other related enzymes are available from DSM under the registered trade mark CakeZyme® or BakeZyme® H (which is described as particular alpha-amylase preparation obtained by cultivating a selected strain of Aspergillus oryzae).

WO2014-006090 (DSM) describes use of a xylanase in dough or batter to produce more crisp products with a longer shelf life. The invention requires that crisp baked product after storage has a water activity (aw) of at least 0.35 while having at least 80% of the hardness of a reference crisp baked product prepared with no added xylanase.

WO2002-024926 (DSM) describes certain xylanases obtained from Talaromyces and their use in degrading xylan cellulose in the fields of baking, animal feed and paper production.

WO2011-124678 (Danisco) describes a method for the modification of cereal bran using a cell-wall modifying enzyme to improve the water holding capacity (WHC) of the bran.

EP0372596 (Proctor & Gamble) describes dual textured cookies made with filling having low water activity (from 0.2 to 0.35) and fibre. The crispness of the cookies' outer dough is preserved whilst the filing tastes soft creating the dual texture.

EP1415539 (Nestec) describes a flour based food product (such as wafers, biscuits or crackers) comprising thermostable alpha-amylase and in-situ modified starch, to manipulate textural attributes of the food product without increasing batter viscosity. This document does not suggest that a high fat content can be used.

EP1982598 (Nestec) discloses a moisture resistant wafer which retains its crispy texture when exposed to moisture.

JP 08-84557 (Ezaki Glico) describes a baked cake with crisp and meltable mouth feel that is prepared by treating dough with xylanase before baking to decompose pentosan and modify the viscosity and water absorbing properties of the dough to improve palatability of the baked cake.

U.S. Pat. No. 5,176,927 (Cultor) describes a method of improving the production process of dry cereal products by enzyme addition

U.S. Pat. No. 6,660,314 (Nestec) describes a flavour filling for baked flour based products, the filling having low water activity.

Collins et al, Fems. Microbiol. Rev. vol. 29, 2005, pages 3-23, describes certain xylanases, xylanase families and extremophilic xylanases. The contents of this document are incorporated herein by reference and optionally the enzymes described in this paper may be used in the present invention.

These prior art documents have described various enzymes and/or how some of these enzymes are used to address certain problems in the baking industry, but none have provided a practical solution to the problems identified herein.

It is an object of the present invention to address some or all of the problems identified herein.

Accordingly, broadly in accordance one aspect of the invention there is provided a process for the production of a baked foodstuff such as a wafer, the process comprises the steps of:

(a) providing a batter comprising

(i) at least 5 parts by weight of fat;

(ii) 100 parts by weight of flour that comprises hard flour, soft flour or mixtures thereof; in which where the flour is 100% hard flour it is present in an amount of at least 40% by weight of the total amount of ingredients (i), (ii) and (iv); where the flour is 100% soft flour it is present in an amount of at least 50% of the total amount of ingredients (i), (ii) and (iv), and where the flour comprises a mixture of hard and soft flours, they are present in at least that amount as a minimum weight percentage of the total amount of ingredients (i), (ii) and (iv) that corresponds proportionally to the respective proportion of hard and soft flour within the flour mixture;

(iii) an amount of water so the weight ratio of total amount of water to total amount of flour in the batter (denoted herein as R[w/f]) is no more than 1.5;

(iv) at least one enzyme comprising a cellulase in an amount of at least 0.0001 parts by weight;

(b) mixing the batter to achieve a viscosity of from 200 to 1900 cps measured by the method as described herein.

(c) feeding the batter to a heated baking surface through a batter depositor; and

(d) baking the batter to obtain a baked foodstuff such as a wafer.

Where the flour is a mixture of hard and soft flours other flours may also be added to the mixture (such as low grade flours), but preferably if a mixture the flour consists of hard flour and soft flour only (both as defined herein).

Broadly a still a further aspect of the invention provides a wafer obtained and/or obtainable by the process of the present invention.

In a yet still further aspect of the invention there is provided a batter for a baked foodstuff such as wafer, the batter comprising

(i) at least 5 parts by weight of fat

(ii) 100 parts by weight of flour that comprises hard flour, soft flour or mixtures thereof; in which where the flour is 100% hard flour it is present in an amount of at least 40% by weight of the total amount of ingredients (i), (ii) and (iv); where the flour is 100% soft flour it is present in an amount of at least 50% of the total amount of ingredients (i), (ii) and (iv), and where the flour comprises a mixture of hard and soft flours, they are present in at least that amount as a minimum weight percentage of the total amount of ingredients (i), (ii) and (iv) that corresponds proportionally to the respective proportion of hard and soft flour within the flour mixture; and

(iii) an amount of water so the weight ratio of total amount of water to total amount of flour in the batter (denoted herein as R[w/f]) is no more than 1.5;

(iv) at least one enzyme comprising a cellulase in an amount of at least 0.0001 parts by weight;

(b) mixing the batter to achieve a viscosity of from 100 to 1900 cps measured by the method as described herein.

(c) feeding the batter to a heated baking surface through a batter depositor; and

(d) baking the batter to obtain a baked foodstuff such as a wafer.

One aspect of the invention provides a baked foodstuff obtained and/or obtainable by a process of the present invention.

Broadly a yet other aspect of the invention provides a baked foodstuff such as a wafer comprising

(i) at least 5 parts by weight of fat

(ii) 100 parts by weight of flour that comprises hard flour, soft flour or mixtures thereof; in which where the flour is 100% hard flour it is present in an amount of at least 40% by weight of the total amount of ingredients (i), (ii) and (iv); where the flour is 100% soft flour it is present in an amount of at least 50% of the total amount of ingredients (i), (ii) and (iv), and where the flour comprises a mixture of hard and soft flours, they are present in at least that amount as a minimum weight percentage of the total amount of ingredients (i), (ii) and (iv) that corresponds proportionally to the respective proportion of hard and soft flour within the flour mixture; and

(iii) an amount of water so the weight ratio of total amount of water to total amount of flour in the batter (denoted herein as R[w/f]) is no more than 1.5;

(iv) at least one enzyme comprising a cellulase in an amount of at least 0.0001 parts by weight,

Baked foodstuffs of the invention may be sweet or savoury. Preferred baked foodstuffs are wafers, which may be flat or shaped (for example into a cone or basket for ice-cream). More preferred wafers are non-savoury wafers, for example having a sweet or plain flavour. Most preferred wafers are sweet and flat or cone shaped, for example sweet flat wafers. Usefully the wafer may suitable for subsequent lamination to form a multi wafer layed product optionally together with a confectionery or fruit based filling to form a confectionery product (which may or may not be enrobed in whole or in part in a coating comprising chocolate or other fat based confectionery).

The present invention provides a baked foodstuff such as wafer with a recipe (compared to a conventional wafer) that has a much higher fat content (and therefore more pleasurable taste) whilst still being made economically in a conventional industrial process.

Certain thermostable alpha-amylase enzymes are known to reduce viscosity in mixtures of flour and water alone (see for example paragraph [006] of the applicant's patent application EP1415539). However the prior art teaches that the thermostable alpha amylase acts during the baking step so would not have an influence on viscosity before baking and hence on pumpability etc. A lower temperature acting alpha amylase would reduce the viscosity of the batter but not to the extent of the xylanases and would release small sugars leading to stickiness on the baking plates.

However it had previously been believed that such alpha-amylase enzymes (which are concerned with the modifying starch in an aqueous phase) would be much less active in a batter formulation with too high (>5%) a content of fat and/or would have to be used in too great amounts which might adversely affect the wafer taste. It also had been thought that it would be undesirable to lower the viscosity of such a formulation still further as there would be a danger that the combined effects of large amounts of fat and enzyme (even if it could made sufficiently active) would produce too great a cumulative effect and thus an unacceptably thin batter

Surprisingly the applicant has found that if flour with much higher amounts of fat and/or much harder flours are used than previously used in conventional wafer batters high fat recipes can still be processable, for example if the amounts of the specific enzymes are incorporated into the batter as described herein. Surprisingly the applicant has found one hemicellulase (such as that enzyme available commercially from DSM under the registered trade mark BakeZyme® H) which has sufficient power to decompose any of the hemicellulose complex in flour, including arabinoxylans (=pentosans).

Without wishing to be bound by any theory it is believed that flour with high amounts of fat flour and/or hard flour used may form a three dimensional network structure which counteracts the tendency of the fat in the batter to flow. The batter of the invention is thus sufficiently viscous to remain on a heated surface long enough to form a baked wafer without spillage or leakage. Yet by incorporating the correct type and amount of enzyme in a batter having a high amount of fat and/or hard flours can still flow sufficiently to be pumped into a batter depositor for use in an industrial wafer baking process thus allowing industrial scale production of wafers with a high fat content.

Baked Foodstuff

Preferably the baked foodstuff is a wafer.

Wafers may be distinguished from other biscuits/cookies in that wafers are the result of baking a batter whereas biscuits/cookies are usually baked out of a dough. Batter is a liquid suspension that will flow through a pipe whereas biscuit dough is rather stiff to permit rolling and flattening and normally has a water content of less than 50 parts per 100 parts of flour.

The amounts of batter ingredients are given herein as parts by weight unless stated otherwise or it is clear from the context a different measure is being used. Usefully in the present invention the units of parts by weight given herein may also be converted into the same number if a percentage based on the total weight of batter.

Another aspect of the present invention relates to a baked foodstuff such as a wafer obtained or obtainable by the method of the present invention.

Fat

The wafer of invention is prepared from a batter that comprise at least 5 parts by weight of fat. The fat is added impart a different flavour to the wafer.

The term ‘fat’ as used herein denotes any edible fat or oil whether solid or liquid at ambient temperature and obtained and/or obtainable from any natural source (e.g. plant and/or animal) and/or synthetically produced. A non-limiting list of suitable fats for use in the present invention comprise: copra, plant oils (such as olive oil, palm oil (such as RDPKO which denotes Refined Deodorized Palm Kernel Oil), sunflower oil and/or other nut oils), ghee, butter, hydrogenated oils and/or fats, lard, margarine, saturated fats and/or oils, unsaturated fats and/or oils (such as mono or poly unsaturated), shortening, suet and/or any suitable mixtures thereof.

Conveniently the fat is present in the batter mixture in an amount of fat least 6 parts by weight, more conveniently at least 8 parts by weight, most conveniently at least 10 parts by weight, for example at least 15 parts by weight.

Advantageously the fat is present in the batter mixture in an amount less than or equal to 50 parts by weight, more advantageously less than or equal to 40 parts by weight, even more advantageously less than or equal 30 parts by weight, most advantageously less than or equal 25 parts by weight for example less than or equal 22 parts by weight.

Preferably the fat is present in the batter mixture in an amount of from 5 to 50 parts by weight, more preferably from 6 to 40 parts by weight, even more preferably from 8 to 30 parts by weight, most preferably from 10 to 25 parts by weight for example from 15 to 22 parts by weight.

It will be appreciated that one aspect of the present invention provides for a baked foodstuff, preferably a wafer, which has a higher fat content (at least 5 parts or 5% by weight) than previously obtainable from an industrial process and thus such wafers may have flavours that substantially correspond to the flavour one or more of the following known high fat recipes which is a non limiting list of those possible: for example recipes selected for high fat biscuits, cakes, breads, pastries and/or pies; such as from the group consisting of: ANZAC biscuit, biscotti, flapjack, kurabiye, lebkuchen, leckerli, macroon, bourbon biscuit, butter cookie, digestive biscuit, custard cream, florentine, garibaldi gingerbread, koulourakia, kourabiedes, Linzer torte, oreo, Nice biscuit, peanut butter cookie, polvorón, pizzelle, pretzel, croissant, shortbread, cookie, fruit pie (e.g. apple pie, cherry pie), lemon drizzle cake, banana bread, carrot cake, pecan pie, apple strudel, baklava, berliner, bichon au citron and/or similar recipes.

Flour

A batter for a wafer usually comprises around 40 to 50 parts by weight a soft wheat flour.

The wafers of the present invention have a much higher amount fat in one embodiment of the invention the flour comprises hard flour to provide sufficient structure to the batter to make it processable.

Wheat can be classified in many different ways by different national and international bodies. For example the trade body Wheat Quality Australia in their latest (as of the filing dated of the present application) Wheat Classification Guidelines dated October 2013 (the contents of which are hereby incorporated by reference) classifies wheat into the following categories: Australian Prime Hard (APH), Australian Hard (AH), Australian Premium White (APW), Australian Standard White (ASW), Australian Premium Durum (APDR), Australian Soft (ASFT), Australian Standard Noodle (ASWN), Australian Premium Noodle (APWN) and Australian Feed (FEED).

The United States classifies wheats into five grades from 1 (hardest) to 5 (softest) and also into the following different wheat categories:

Durum (D) wheat is a very hard, translucent, light-coloured grain used to make semolina flour for pasta and bulghur and has a high gluten content.

Hard Red Spring (HRS) wheat is a hard, brownish, high-protein wheat used for bread and hard baked goods commonly used to make bread flour and high-gluten flours.

Hard Red Winter (HRW) wheat is a hard, brownish, mellow high-protein wheat used for prepare bread, hard baked goods and as an adjunct in other flours to increase protein in pastry flour for pie crusts. HRW is often used as the sole component of unbleached all-purpose flours.

Hard White (HW) wheat is a hard, light-coloured, opaque, chalky, medium-protein wheat planted in dry, temperate areas and is used for bread and brewing.

Soft Red Winter (SRW) wheat is a soft, low-protein wheat used for cakes, pie crusts, biscuits, and muffins and typically used to make cake flour, pastry flour, and some self-rising flours with added baking powder and salt.

Soft White (SW) wheat is a soft, light-coloured, very low protein wheat grown in temperate moist areas, commonly used for pie crusts and pastry.

Other US wheat categories are Soft Red Spring (SRS), Unclassed (U), and Mixed (M).

France characterises wheat in the categories of: BAF (corrective/strong wheat), BPS (superior bread making), BPC (standard bread making), BAU (Other uses, biscuits or feed). Germany characterises wheat in the categories of: E (elite), A (quality bread), B (standard bread), K (biscuit). Since 2004 the United Kingdom has characterises wheat for export from the UK as ukp (bread wheat) and uks (soft wheat) based on the following criteria.

| | ukp | | uks | |
|---|---|---|---|---|
| Specific Weight | 76 kg/hl | (min) | 75 kg/hl | (min) |
| Moisture content | 15% | (max) | 15% | (max) |
| Ad mix | 2% | (max) | 2% | (max) |
| Hagberg Falling Number (HFN) | 250 | (min) | 220 | (min) |

| | | |
|---|---|---|
| Protein | 11-13% | 10.5-11.5% |

An alternative method of characterising wheat in the UK, groups wheat into five different categories namely: Group 1: strong bread wheat; Group 2: medium strength bread wheat; Group 3: soft biscuit/cake wheat (typically used to make wafer e.g. for confectionery products); Group 4: soft; and Group 5: hard. Groups 4 and 5 are designated as such because they fail the requirements for Group 1 to 3 and are thus used for animal feed and increasingly bio-fuel. However UK Groups 4 and 5 may not necessarily satisfy some or all of the criteria specified herein for soft and hard wheat.

Similar and comparable standards to define wheat grades exist in other territories.

Soft Flour

Soft flour as used herein denotes flour that has a low protein content, preferably having a protein content of up to 11%, more preferably no more than 10%, most preferably from 8% to 10% by weight.

Soft flour as used herein denotes flour that has a low protein content, preferably having a protein content of less than 11%, more preferably less than 10%, most preferably less than 9%, by weight of total weight of flour. Usefully the protein content of soft flour is at least 5%, more usefully at least 6%, most usefully at least 7% by weight of total weight of flour. Conveniently soft flour has a protein content from 5% up to 11%, more conveniently from 6% to 10%, most conveniently from 7% to 9% by weight of total weight of flour.

As used herein the term soft wheat preferably denotes wheat that falls into the definitions referred to above by Wheat Quality Australia dated October 2013 classified as ASFT and/or that falls into the US definitions for SRW, SSW and/or SW wheat, and/or falls into (the softest) Grade 5 as defined under USA wheat standards and/or K wheat in Germany and/or uks wheat for export from the United Kingdom and/or satisfies the definitions for any equivalent, comparable and/or similar types of wheat to these standards as defined in other territories. Therefore in another embodiment of the invention the term soft flour usefully denotes a flour obtained and/or obtainable from (more usefully milled directly from) one or more soft wheat(s) as defined herein.

It will be understood as used herein that for convenience in one embodiment of the invention if there is an inconsistency between the amounts in wt % of protein specified herein for hard, soft and low grade flours and any of the territorial definitions also referred to herein for hard and soft and low grade wheat classes, then the wt % values specified herein prevail and/or usefully that fraction of a given wheat class that lie outside the wt % specified herein are excluded from the definition of soft, hard and/or low grade wheat as used herein.

Non Wheat Flours

In further embodiment of the invention conveniently the flour comprises instead of or in additional to the wheat flour a non-wheat flour. More conveniently the non-wheat flour is obtained and/or obtainable from one or more of the following sources of grain: non-wheat cereals such as rye, common oat (Avena sativa, also referred to herein as oats), rice and/or bran; legumes such as beans and/or soybeans; and/or suitable mixtures thereof.

Non-wheat food grade crops (such as cereal grains) and that are suitable for producing flours for use in the present invention are selected from the group consisting of: warm season cereals (such as maize kernels; finger millet; fonio. foxtail millet; Kodo millet; Japanese millet. Job's Tears; maize (corn); pearl millet; proso millet; and/or sorghum); cool season non wheat cereals (such as barley, oats, rice, rye, teff, triticale and/or, wild rice); pseudocereal grains; (such as starchy grains from broadleaf plant families: amaranth buckwheat, smartweed and/or quinoa); grain legumes and/or pulses (such as lentil, pea, chickpeas, common beans, fava beans, garden peas, lentils, lima beans, lupins, mung beans, peas, peanuts, pigeon peas, runner beans and/or, soybeans), cassava (Maihot esculenta) and/or any suitable combinations and/or mixtures thereof.

Cassava is an important subsistence crop in many tropical areas including, for example, Asia, Africa and Latin America. The cassava roots are a major source of carbohydrates such as starch. This starch from the cassava root can be extracted to produce cassava starch also known as tapioca starch or tapioca flour. Cassava flour is made by cooking, drying and grinding cassava root to a fine powder. This is different from cassava starch which is made from the starch of the cassava plant whereas the cassava flour is made from the ground root. Both tapioca flour and cassava flour can be used in the present invention.

Preferred flours are those obtained and/or obtainable from millet; maize, barley, oats, rice, rye and/or soybeans).

More preferred flours are those obtained and/or obtainable from barley, oats, rice and/or rye, most preferred flours are those obtained from rye and/or oats, such as from oats. An example of oats as used herein is the common oat (Avena sativa).

The low grade wheat flour where present may be present in an amount of at least 10 parts by weight, conveniently at least 6 parts by weight, more conveniently at least 8 parts by weight, even more conveniently at least 10 parts by weight, most conveniently at least 15 parts by weight, for example at least 100 parts by weight of the total flour.

Advantageously in this embodiment the low grade wheat flour may be present in the batter mixture in an amount less than or equal to 50 parts by weight, more advantageously less than or equal to 40 parts by weight, most advantageously less than or equal 30 parts by weight, for example less than or equal 25 parts by weight of the total flour.

Preferably in this embodiment the low grade wheat flour may be present in the batter mixture in an amount of from 5 to 50 parts by weight, more preferably from 6 to 40 parts by weight, most preferably from 8 to 30 parts by weight, for example from 10 to 25 parts by weight of total flour.

Hard Flour

Hard flour as used herein denotes flour that has a high protein content, preferably having a protein content of more than 11%, more preferably at least 12%, most preferably at least 13%, for example at least 14% by total weight of flour. Usefully the protein content of hard flour is no more than 20%, usefully no more than 17%, more usefully no more than 15% by total weight of flour. Conveniently hard flour has a protein content from 11% to 20%, more conveniently from 12% to 17%, most conveniently from 13% to 15% by total weight of flour.

As used herein the term hard wheat preferably denotes wheat that falls into the definitions referred to above by Wheat Quality Australia dated October 2013 classified as APH, AH, ASW and/or APDR and/or that falls into the US definitions for D, HRS, HRW and/or HW wheat, and/or falls into (the hardest) Grades 1, 2, 3 and/or 4 as defined under USA wheat standards and/or BAF, BPS and/or BPC wheat in France and/or E, A and/or B wheat in Germany and/or ukp wheat for export from the United Kingdom and/or satisfies the definitions for any equivalent, comparable and/or similar types of wheat to these standards as defined in other territories. Therefore in one embodiment of the invention the term hard flour conveniently denotes a flour obtained and/or obtainable from (more conveniently milled directly from) one or more hard wheat(s) as defined herein.

In another embodiment of the invention (which may be separate from or combined with low grade-wheat flours) the flour may comprise hard flour as defined herein.

The hard flour where present may be present in an amount of at least 5 parts by weight, conveniently at least 6 parts by weight, more conveniently at least 8 parts by weight, even more conveniently at least 10 parts by weight, most conveniently at least 15 parts by weight, for example at least 20 parts by weight of the total flour.

Advantageously in this embodiment the hard flour may be present in the batter mixture in an amount less than or equal to 50 parts by weight, more advantageously less than or equal to 40 parts by weight, most advantageously less than or equal 30 parts by weight, for example less than or equal 25 parts by weight of the total flour.

Preferably in this embodiment the hard fibre may be present in the batter mixture in an amount of from 5 to 50 parts by weight, more preferably from 6 to 40 parts by weight, most preferably from 8 to 30 parts by weight, for example from 10 to 25 parts by weight of total flour.

In one embodiment of the invention the batter may comprise flours in an amount typical for a wafer recipe, such as from 40 to 50% by weight of the batter.

In another embodiment of the invention the batter may comprise harder flours and/or more flour that in a conventional wafer recipe such as given below. Optionally the batter comprises a similar amount of flour (from 40 to 50 parts by weight) than in a conventional wafer batter using soft flour but uses harder flour i.e. having have a much higher gluten content.

Preferably in yet other embodiment the flour comprises a mixture of flours at least 50 parts by weight of which of which is a hard flour, more preferably substantially consists (most preferably consist of) hard flour.

Low Grade Flour

In one embodiment of the invention conveniently the flour is a low grade-wheat flour which is obtained and/or obtainable from a low grade wheat and/or denotes flour is obtained and/or obtainable from one or more of the following sources of wheat cereal; brown flour (comprising germ and/or bran) wholegrain flour (also known as whole-meal flour, comprising the entire grain, including the bran, endosperm, and germ); germ flour (comprising the endosperm and germ, excluding the bran); and/or any suitable mixtures thereof.

As used herein the term low grade wheat preferably denotes wheat that falls into the definitions for wheat classified by Wheat Quality Australia in October 2013 as ASWN, APWN and/or FEED and/or that falls into the US definitions for U and/or M wheat and/or does not meet the requirements to satisfy any of Grades 1, 2, 3, 4 and/or 5 as defined under US wheat standards and/or BAU wheat in France and/or K wheat in Germany and/or satisfies the definitions for any equivalent, comparable and/or similar types of wheat to these standards as defined in other territories. Therefore in a still other embodiment of the invention the term low grade flour advantageously denotes a flour obtained and/or obtainable from (more advantageously milled directly from) one or more low grade wheat(s) as defined herein.

Gluten is a protein composite found in the endosperm of many cereal grains such as wheat. Gluten comprises two major components gliadin and glutenin. Gliadins comprises monomeric, small molecule proteins that exist in different forms (referred to as alpha (α), beta (β), gamma (γ), and omega (ω)) based on their amino acid content. Typically persons with coeliac (or celiac) disease are intolerant to gliadins. Glutenins comprise polymeric proteins of both high and low molecular weights that form an aggregate stabilised by cross-links between the polymer chains such as disulfide bonds and/or H bonding and provide strength and elasticity to a dough.

Preferably at least 60%, more preferably at least 70%, even more preferably at least 80%, most preferably at least 90% by weight of total amount of protein in the flour is gluten. Some non-wheat flours such as those from cassava, oats and/or millet are free of gluten. A hard wheat flour has a high amount of protein and therefore may also have both in absolute amount and in proportion to the total amount of protein a high content of gluten.

Uthayakumara et al in Cereal Chem. 76(3):389-394, 1999 describes the effect of varying glutenin-to-gliadin ratio on the properties of wheat dough. The contents of this paper are incorporated herein by reference. The method described in this paper is used herein to measure glutenin and gliadin content. Gliadin is isolated from gluten by precipitation from hydrochloric acid at pH 5.3 and glutenin by precipitation from hydrochloric acid at pH 3.9. The glutenin and gliadin contents were determined in triplicate by size-exclusion HPLC and glutenin was defined as Peak I and gliadin as Peak II as described in the aforementioned paper (or other references cited therein).

Flour Amount

The flour may be present in a still other embodiment in the batter mixture in an amount of at least 51 parts by weight, conveniently at least 55 parts by weight, more conveniently at least 60 parts by weight, most conveniently at least 65 parts by weight, for example at least 70 parts by weight.

Advantageously in a still other embodiment the flour may be present in the batter mixture in an amount less than or equal to 95 parts by weight, more advantageously less than or equal to 90 parts by weight, most advantageously less than or equal 85 parts by weight, for example less than or equal 80 parts by weight.

Preferably in a still other embodiment the flour may be present in the batter mixture in an amount of from 51 to 95 parts by weight, more preferably from 55 to 90 parts by weight, most preferably from 60 to 85 parts by weight, for example from 65 to 80 parts by weight.

Usefully the amounts of flour (or any other ingredient) herein expressed as parts by weight may also be the same number considered as a weight percentage of the total weight of batter.

Ratio Water to Flour—R(w/f)

Optionally the weight ratio of water to flour (denoted herein as R[w/f]) is no more than 1.5, optionally from 0.5 to 1.5.

Conveniently R(w/f/) is at least 0.7, more conveniently at least 0.8, most conveniently at least 0.9, for example at least 1.0.

Advantageously R(w/f/) is less than or equal to 1.5, more advantageously less than or equal to 1.4, even more advantageously less than or equal to 1.3, most advantageously less than or equal 1.2, for example less than or equal 1.0.

Preferably R(w/f/) is from 0.6 to 1.5, more preferably from 0.7 to 1.4, even more preferably from 0.8 to 1.3, most preferably from 0.9 to 1.2, for example from 0.9 to 1.0.

Enzyme

Batters as used in the present invention comprise at least one enzyme comprising a cellulase which is an enzyme that catalyse the decomposition of cellulose and related polysaccharides (cellulolysis) into monosaccharides (simple sugars such as beta-glucose), shorter polysaccharides and/or oligosaccharides.

As used herein the term cellulase denotes any mixture or complex of enzymes, that act serially and/or synergistically to decompose cellulosic material. Thus cellulase encompasses both cellulase, hemicellulase, synonyms thereof, derivatives thereof, different structural forms thereof, all enzymes that achieve celluolysis by any mechanism; (for example by hydrolysis of the 1,4-beta-D-glycosidic linkages in cellulose) and/or any mixtures thereof.

Examples of suitable cellulases comprise one or more of the following: endo-1,4-beta-D-glucanase, beta-1,4-glucanase, beta-1,4-endoglucan hydrolase, endoglucanase D, 1,4-(1,3,1,4)-beta-D-glucan 4-glucanohydrolase, carboxymethyl cellulase (CMCase), avicelase, celludextrinase, cellulase A, cellulosin AP, alkali cellulase, cellulase A 3, 9.5 cellulase, pancellase SS, carbohydrase hemicellulase, hemicellulase, lichenin, cereal beta-D-glucans, xylanase, pentosanase and/or mixtures thereof. In one preferred embodiment of the invention the cellulase comprises a hemi-cellulase, xylanase and/or pentosanase.

Without wishing to be bound by any theory it is believed that xylanases and/or pentosanases act to hydrolyse the xylan backbone in arabinoxylan (pentosan) and decrease the capacity of wheat to bind water. Thus the use of these enzymes may also act to release water into the batter.

Preferably the enzyme is added to the batter before the baking step and does not need to be thermally stable as it acts before the baking step to influence viscosity so that the batter can be delivered (e.g. by pumping) to the batter depositor and can also be baked on a heated plate without spillage or leaks.

Preferred enzymes are hemi-cellulases, more preferably xylanases, more preferably pentonases such one of such enzymes available commercially from DSM under the registered trade mark Bakzyme®.

The batter may comprise a total amount of all enzymes in an amount at least 0.0001 parts by weight, conveniently at least 0.0002 parts by weight, more conveniently at least 0.0005 parts by weight, most conveniently at least 0.001 parts by weigh

Advantageously the total amount of all enzymes present in the batter in an amount less than or equal to. 0.4 parts by weight, more advantageously less than or equal to 0.3 parts by weight, most advantageously less than or equal 0.2 parts by weight, for example less than or equal 0.1 parts by weight.

Preferably the total amount of enzyme is present in the batter mixture in an amount of from 0.0002 to 0.4 parts by weight, more preferably from 0.0005 to 0.3 parts by weight, most preferably from 0.001 to 0.2 parts by weight, for example from 0.01 to 0.1 parts by weight of the total amount of batter.

Optionally the enzyme of the invention comprises a cellulase combined with one or more other enzyme(s) preferably selected from one or more amylase, one or more serine peptidases and/or one or more proteinase.

In one embodiment of the invention the enzyme does not contain a thermostable alpha amylase, usefully is free of any alpha amylase. A thermostable alpha amylase if present during the baking stage would also release small sugars leading to stickiness on the baking plates which is not desired. A lower temperature acting alpha amylase can be used to reduce the viscosity of the batter before baking. However such an amylase is not as effective at reducing viscosity as xylanases. So in general alpha amylases are not preferred.

Proteinases may be used to hydrolyse the peptide bonds in wheat gluten and reduce or prevent the tendency of lumps of gluten to form in the batter. Where present the proteinase may comprise endo-proteinases (such as neutral bacterial proteinase from Bacillus subtilis or papain from Carica papaya).

The total amount of enzyme incorporated into the batter where a mixture of enzyme types may comprise cellulase in a proportion of the total enzyme of from 25% to 100%, preferably from 50% to 95% and more preferably from 75% to 90% by weight based on the total weight of all the enzymes. In a preferred embodiment of the invention the enzyme consists of approximately 33% by weight of cellulase (such as a hemicellulase, e.g. that available commercially from DSM under the registered trade mark Bakzyme®) and 67% by weight of proteinase by total weight of enzyme.

It will be understood that optionally in one embodiment of the invention the enzyme may consist of 100% cellulase in which case the amounts given herein for the total amount of enzyme correspond to the total amount of cellulase.

Viscosity

A batter of the present invention has a viscosity of from 200 to 1900 cps.

The term “viscosity” as used herein refers to the apparent viscosity of a fluid (e.g. batter) as measured by conventional methods known to those skilled in the art but in particular the method described below is preferred. Some fluids display non-Newtonian rheology and cannot be totally characterized by a single rheological measurement point. Despite this, apparent viscosity is a simple measure of viscosity useful for the evaluation of such fluids.

The preferred method for measuring viscosity (e.g. of batter examples according to the invention, as well as comparative examples) uses an instrument denoted by the trade designation RVA 4500 (available commercially from Rapid Viscosity Analyzer, Newport Scientific, Australia). The method used is a follows: 10 grams of flour in 10 grams of water and the corresponding amount of the enzyme (where present) were mixed in the canister supplied with the RVA instrument in the following order; water, enzyme, mix for 10 seconds, add the flour and then the measurement test is started. The RVA measurements were performed using the following profile: a constant temperature of 35° C., mix vigorously at 950 rpm for 10 seconds then at 160 rpm for the duration of the test which is 30 minutes. The test is done in duplicates or triplicates to ensure repeatability. The final viscosity is used for comparison as well as the quality of the RVA viscosity curve i.e. smoothness and rate of enzyme action. A viscosity below 1900 cPs in this test indicates that the batter is of good quality and processable on a wafer production line. A viscosity less than 200 cPs in this test is considered too low for the batter to be bakable on a hot plate without spillage and/or the other issues described herein.

Conveniently the batter viscosity is at least 250 cps, more conveniently at least 300 cps, even more conveniently at least 500 cps, most conveniently at least 700 cps, for example at least 800 cps.

Advantageously R(w/f/) is less than or equal to 1800 cps, more advantageously less than or equal to 1700 cps, even more advantageously less than or equal to 1500 cps, most advantageously less than or equal 1400 cps, for example less than or equal 1200 cps.

Preferably R(w/f/) is from 250 to 1800 cps, more preferably from 300 to 1700 cps, even more preferably from 500 to 1500 cps, most preferably from 700 to 1400 cps, for example from 800 to 1200 cps.

Other Ingredients

The batter herein may comprise other ingredients in addition to water, fat, flour and enzyme.

Such other ingredients are described herein and may include salt for a savoury wafer and/or sugar for a sweet wafer. Common formulations of batter may also comprise at least one of the following additional other ingredients: selected from one or more of: lecithin, emulsifier, sugar (such as invert sugars), whole egg, salt, skim milk powder, soy flour, yeast and/or mixtures thereof.

The cellular structure of a wafer can be further strengthened using known stabilisers such as starch, modified starch, gums such as locust bean gum, guar gum, gum acacia, tragacanth, xanthan, karaya, gellan, tars, cellulose and cellulose derivatives, pectin or gelatin, maltodextrins, gelling agents such as alginates or carageenan, proteins or protein sources such as albumins, casein, caseinates, milk powders or whey powders.

The wafers of the present invention can also be modified as described in the applicant's patent applications EP1415539, EP1982598, and/or EP2587926 Usefully the total amount of other ingredients in the batter is no more than 10 parts by weight, more usefully no more than 5 parts by weight, most usefully no more than 2 parts by weight. In one preferred embodiment of the invention the batter is substantially free of other ingredients more preferably consists of fat, water, flour and enzyme.

Baking Process

Preferred baking temperature is from 110° C. to 180° C. and the preferred baking time is from 90 seconds to 4 minutes. However the exact time which is optional in each case will depend on wafer thickness, recipe and type of wafer sheet being produced (e.g. flat or shaped wafer sheets).

In a preferred embodiment of the present invention the method comprises a step of baking in a conventional wafer baking oven that comprises moving hot plates.

In another embodiment of the present invention, the heated baking surface is a wafer baking mould comprising two plates locked in position to constrain the batter during the baking time.

The quality of wafer sheets may be controlled by flour property, ratio of water to flour in the batter and batter temperature, mixing action, baking time and temperature. The quality may be judged by attributes of the batter such as the effective density, viscosity, holding time and temperature, and by properties of the wafer such as weight, surface colour, fragility, breakage force and moisture content.

In one embodiment of the present invention relates to a wafer having: (i) a breakage force of at least 1N when measured as described herein

The term breakage force is to be understood in the context of the present invention as the force required to break the wafer and is measured by a 3-point bend test as detailed below. The 3-point bend breakage test is performed with a TA.HD Plus Texture Analyser from Stable Micro Systems using a three point bend rig and Exponent software to drive this rig as supplied by this company. The test was performed under standard conditions.

The force is applied to the centre of a wafer suspended at two points 10 cm apart on struts having horizontal 1 cm diameter cylinders. The size of the wafer piece is 20 cm by 8 cm, and it is placed evenly over the struts. The probe also has a horizontal 1 cm diameter cylinder. A testing speed of the probe of 1.00 mm/second is used together with a 50 kg load cell (also supplied by Stable Micro Systems).

The breakage force relates to the stiffness of the wafer which governs processability and also relates to the crispness of the wafer as perceived by the consumer.

In the context of the present invention, the term “effective density” relates to the weight of sample divided by the “envelope volume of sample”. The envelope volume of the sample relates to the volume defined essentially by the outer surfaces of the sample and includes any porosity within the sample.

In one embodiment of the present invention, the wafer has a breakage force of at least 1N, such as in the range of 1-4N, preferably in the range of 2-4N, and/or an effective density of at most 0.16 g/cm³, such as in the range of 0.08-0.15 g/cm³, preferably in the range of 0.12-0.15 g/cm³.

General

It is appreciated that certain features of the invention, which are for clarity described in the context of separate embodiments may also be provided in combination in a single embodiment. Conversely various features of the invention, which are for brevity, described in the context of a single embodiment, may also be provided separately or in any suitable sub-combination.

The object of the present invention is to solve some or all of the problems or disadvantages (such as identified herein) with the prior art.

Unless the context clearly indicates otherwise, as used herein plural forms of the terms herein are to be construed as including the singular form and vice versa.

The term “comprising” as used herein will be understood to mean that the list following is non exhaustive and may or may not include any other additional suitable items, for example one or more further feature(s), component(s), ingredient(s) and/or substituent(s) as appropriate.

The terms ‘effective’, ‘acceptable’ ‘active’ and/or ‘suitable’ (for example with reference to any process, use, method, application, preparation, product, material, formulation, compound, monomer, oligomer, polymer precursor, and/or polymers described herein as appropriate) will be understood to refer to those features of the invention which if used in the correct manner provide the required properties to that which they are added and/or incorporated to be of utility as described herein. Such utility may be direct for example where a material has the required properties for the aforementioned uses and/or indirect for example where a material has use as a synthetic intermediate and/or diagnostic tool in preparing other materials of direct utility. As used herein these terms also denote that a functional group is compatible with producing effective, acceptable, active and/or suitable end products.

Preferred utility of the present invention comprises use for preparing baked foodstuff such as wafer.

Ranges

In the discussion of the invention herein, unless stated to the contrary, the disclosure of alternative values for the upper and lower limit of the permitted range of a parameter coupled with an indicated that one of said values is more preferred than the other, is to be construed as an implied statement that each intermediate value of said parameter, lying between the more preferred and less preferred of said alternatives is itself preferred to said less preferred value and also to each less preferred value and said intermediate value.

For all upper and/or lower boundaries of any parameters given herein, the boundary value is included in the value for each parameter. It will also be understood that all combinations of preferred and/or intermediate minimum and maximum boundary values of the parameters described herein in various embodiments of the invention may also be used to define alternative ranges for each parameter for various other embodiments and/or preferences of the invention whether or not the combination of such values has been specifically disclosed herein.

Percentages

It will be understood that the total sum of any quantities expressed herein as percentages cannot (allowing for rounding errors) exceed 100%. For example the sum of all components of which the composition of the invention (or part(s) thereof) comprises may, when expressed as a weight (or other) percentage of the composition (or the same part(s) thereof), total 100% allowing for rounding errors. However where a list of components is non exhaustive the sum of the percentage for each of such components may be less than 100% to allow a certain percentage for additional amount(s) of any additional component(s) that may not be explicitly described herein.

Substantially

The term “substantially” as used herein may refer to a quantity or entity to imply a large amount or proportion thereof. Where it is relevant in the context in which it is used “substantially” can be understood to mean quantitatively (in relation to whatever quantity or entity to which it refers in the context of the description) there comprises an proportion of at least 80%, preferably at least 85%, more preferably at least 90%, most preferably at least 95%, especially at least 98%, for example about 100% of the relevant whole. By analogy the term “substantially-free” may similarly denote that quantity or entity to which it refers comprises no more than 20%, preferably no more than 15%, more preferably no more than 10%, most preferably no more than 5%, especially no more than 2%, for example about 0% of the relevant whole.

Test Methods (Alphabetical Order):

Unless otherwise indicated all the tests herein are carried out under standard conditions as also defined herein.

Standard Conditions

As used herein, unless the context indicates otherwise, standard conditions means a relative humidity of 50%±5%, ambient temperature (23° C.±2°) It should be noted that embodiments and features described in the context of one of the aspects of the present invention also apply to the other aspects of the invention.

All patent and non-patent references cited in the present application, are hereby incorporated by reference in their entirety.

Further aspects of the invention, embodiments and/or preferred features thereof are also described in the claims herein, the contents of which are also incorporated into this description.

The invention will now be described in further details in the following non-limiting examples.

### EXAMPLES

The following Examples are provided of illustrative purposes only and they are not to be considered in any way limiting to the scope of the present invention.

The skilled person would easily recognise that changes and modifications can be made with respect to the examples which are still within the scope of the claims. That is, the skilled person will recognise many variations in these examples to cover a wide range of formulas, ingredients, processing, and mixtures to rationally adjust the naturally occurring levels of the compounds of the invention for a variety of applications.

It will be appreciated that if (for example in the Examples herein) the weight percentages herein do not add up to 100% (e.g. due to rounding) they can also be considered as recipes where the same numbers for the weight percentage of each ingredient is considered as a relative part by weight.

### Example 1

| Ingredient | Amount by weight percentage of batter |
|---|---|
| Flour1 | 45.04 |
| Water | 49.04 |
| Fat (RDKO) | 5 |
| Protease | 0.02 |
| Bakezyme ® (from DSM) | 0.002 |
| Sodium Bicarbonate | 0.15 |

Flour1 denotes a wheat flour that falls into the classification Soft Wheat (SW) as defined in US standards.

RDKO denotes Refined Deodorized Palm Kernel Oil.

The batter from Example 1 was found to have a viscosity below 1900 cps so that it could be pumpable to a batter depositor and applied to the heated plate. The batter was baked on a heated wafer plate for 2 minutes at a baking temperature of approximately 150° C. to form a baked wafer. The batter had a viscosity above 200 cps so that when baked on a hot plate the batter remained in place during baking with spillage to form consistently uniform wafers without defects.

### Examples 2 to 10

These batters of the invention can be prepared analogously to Example 1 using the ingredients in Table 1 in which all amounts are given as parts by weight. The resultant batters have a viscosity within the desired range so that baked wafers can be prepared from these batters as described analogously to Example 1.

TABLE 1

| Example | Flour (type/wt %) | Water | Fat/wt % | Enzyme (wt %) | Other (wt %) |
|---|---|---|---|---|---|
| 2 | Flour 2/40 | to 100% | 5 | ENZ1 (0.001) | NaHCO₃ (0.1) |
| 3 | Flour 3/45 | to 100% | 10 | ENZ2 (0.003) | — |
| 4 | Flour 4/50 | to 100% | 5 | ENZ3 (0.01) | NH₄HCO₃ (0.2) |
| 5 | Flour 1/55 | to 100% | 10 (butter) | ENZ4 (0.005) | — |
| 6 | Flour 2/60 | to 100% | 20 | ENZ1 (0.001) | — |
| 7 | Flour 3/42 | to 100% | 5 | ENZ2 (0.001) | KHCO₃ (0.2) |
| 8 | Flour 4/44 | to 100% | 20 | ENZ3 (0.001) | — |
| 9 | Flour 1/46 | to 100% | 15 | ENZ4 (0.001) | — |
| 10 | Flour 2/48 | to 100% | 5 | ENZ1 (0.001) | — |
| 11 | Flour 3/55 | to 100% | 10 | ENZ2 (0.001) | — |
| 12 | Flour 4/50 | to 100% | 15 | ENZ3 (0.001) | — |
| 13 | Flour 1/40 | to 100% | 20 | ENZ4 (0.001) | — |
| 14 | Flour 2/50 | to 100% | 5 | ENZ1 (0.001) | NaHCO₃ (0.1) |
| 15 | Flour 3/60 | to 100% | 25 | ENZ2 (0.001) | NaHCO₃ (0.1) |
| 16 | Flour 4/50 | to 100% | 25 | ENZ2 (0.005) | |

Flour2 denotes 100% of a hard flour that falls into the classification Hard Red Spring wheat (HRS) as defined in US wheat standards.

Flour3 denotes 50% soft flour (US SW) and 50% by weight of hard flour (US HRS) by weight of total flour

Flour4 denotes 100% ukp hard flour by weight of total flour;

Flour4 denotes 100% APH flour (as classified by Wheat Quality Australia October 2013) by weight of total flour;

ENZ1 denotes an enzyme mixture consisting of (by weight of total enzyme) the hemicellulase available from DSM under the registered trade mark Bakzyme H (33 wt %) and protenase (66 wt %).

ENZ2 denotes an enzyme mixture consisting of the hemicellulase available from DSM under the registered trade mark Bakzyme® (20%), alpha amylase (20%) and protenase (60%)

ENZ3 denotes an enzyme mixture consisting of Bakzyme® H.

ENZ4 denotes an enzyme mixture consisting of Bakzyme®.

Unless indicated otherwise herein the fat used in all the examples herein was RDPKO.

### Comparative Examples

Comp A

| Ingredient | Parts by weight |
|---|---|
| Flour2 | 50.04 |
| Water | 49.04 |
| Fat (RDKO) | 10 |
| Protease | 0.02 |
| Sodium Bicarbonate | 0.15 |

A batter with a recipe identical to Example 1 is prepared in an analogous manner with the Bakzyme omitted and the soft flour being replaced by hard flour (100% US HRS). The hard flour was used to impart structure to high fat content batter in an attempt to reduce spillage from the baked plate. The batter was found to have a viscosity much higher than 1900 cps even after mixing for several minutes due to the high proportion of hard flour (50%). Such a batter could not be pumped to a batter depositor or applied to the hot plate and thus no wafer could be prepared.

Comp B

| Ingredient | Parts by weight |
|---|---|
| Flour1 | 50.04 |
| Water | 49.04 |
| Fat (RDKO) | 10 |
| Protease | 0.02 |
| Sodium Bicarbonate | 0.15 |

A batter with a recipe identical to Example 1 with the Bakzyme omitted. The batter was found to have a viscosity much too low after mixing for several minutes due to the high fat content. Whilst such a batter could be pumped to a batter depositor it could not be applied to the hot plate without significant leakage and spillage and thus the wafer prepared had many defects such as holes.

1. A process for the production of a baked foodstuff comprising the steps of:
(a) providing a batter comprising
(i) at least 5 parts by weight of fat
(ii) 100 parts by weight of flour that comprises: hard flour, soft flour or mixtures thereof; in which where the flour is 100% hard flour it is present in an amount of at least 40% by weight of the total amount of ingredients (i), (ii) and (iv); where the flour is 100% soft flour it is present in an amount of at least 50% of the total amount of ingredients (i), (ii) and (iv), and where the flour comprises a mixture of hard and soft flours, they are present in at least that amount as a minimum weight percentage of the total amount of ingredients (i), (ii) and (iv) that corresponds proportionally to the respective proportion of hard and soft flour within the flour mixture, and
(iii) an amount of water so the weight ratio of total amount of water to total amount of flour in the batter is no more than 1.5;
(iv) at least one enzyme comprising a cellulase in an amount of at least 0.0001 parts by weight;
(b) mixing the batter to achieve a viscosity of from 200 to 1900 cps;
(c) feeding the batter to a heated baking surface through a batter depositor; and
(d) baking the batter to obtain a baked foodstuff such as a wafer.

2. A baked foodstuff obtained by the method as claimed in claim 1.

3. A batter for a baked foodstuff comprising:
(i) at least 5 parts by weight of fat;
(ii) 100 parts by weight of flour that comprises hard flour, soft flour or mixtures thereof; in which where the flour is 100% hard flour it is present in an amount of at least 40% by weight of the total amount of ingredients (i), (ii) and (iv); where the flour is 100% soft flour it is present in an amount of at least 50% of the total amount of ingredients (i), (ii) and (iv), and where the flour comprises a mixture of hard and soft flours, they are present in at least that amount as a minimum weight percentage of the total amount of ingredients (i), (ii) and (iv) that corresponds proportionally to the respective proportion of hard and soft flour within the flour mixture;
(iii) an amount of water so the weight ratio of total amount of water to total amount of flour in the batter is no more than 1.5;
(iv) at least one enzyme comprising a cellulase in an amount of at least 0.0001 parts by weight; and
where the batter has a viscosity of from 200 to 1900 cps.

4. A baked wafer comprising
(i) at least 5 parts by weight of fat;
(ii) 100 parts by weight of flour that comprises hard flour, soft flour or mixtures thereof; in which where the flour is 100% hard flour it is present in an amount of at least 40% by weight of the total amount of ingredients (i), (ii) and (iv); where the flour is 100% soft flour it is present in an amount of at least 50% of the total amount of ingredients (i), (ii) and (iv), and where the flour comprises a mixture of hard and soft flours, they are present in at least that amount as a minimum weight percentage of the total amount of ingredients (i), (ii) and (iv) that corresponds proportionally to the respective proportion of hard and soft flour within the flour mixture;
(iii) an amount of water so the weight ratio of total amount of water to total amount of flour in the batter is no more than 1.5; and
(iv) at least one enzyme comprising a cellulase in an amount of at least 0.0001 parts by weight.

5. A process as claimed in claim 1, in which the hard flour is obtained and/or obtainable from wheat selected from the group consisting of: wheat that falls into the definitions referred to above by Wheat Quality Australia dated October 2013 classified as APH, AH, ASW, APDR, falls into the US definitions for D, HRS, HRW, HW wheat, and falls into (the hardest) Grades 1, 2, 3, and 4 as defined under USA wheat standards, BAF, BPS, and BPC wheat in France and E, A and B wheat in Germany and ukp wheat for export from the United Kingdom and satisfies the definitions for any equivalent, comparable and similar types of wheat to these standards as defined in other territories.

6. A batter as claimed in claim 3, in which the hard flour is obtained and/or obtainable from wheat selected from the group consisting of: wheat that falls into the definitions referred to above by Wheat Quality Australia dated October 2013 classified as APH, AH, ASW, APDR, falls into the US definitions for D, HRS, HRW, HW wheat, and falls into (the hardest) Grades 1, 2, 3, and 4 as defined under USA wheat standards, BAF, BPS, and BPC wheat in France and E, A and B wheat in Germany and ukp wheat for export from the United Kingdom and satisfies the definitions for any equivalent, comparable and similar types of wheat to these standards as defined in other territories.

7. A baked wafer as claimed in claim 4, in which the hard flour is obtained and/or obtainable from wheat selected from the group consisting of: wheat that falls into the definitions referred to above by Wheat Quality Australia dated October 2013 classified as APH, AH, ASW, APDR, falls into the US definitions for D, HRS, HRW, HW wheat, and falls into (the hardest) Grades 1, 2, 3, and 4 as defined under USA wheat standards, BAF, BPS, and BPC wheat in France and E, A and B wheat in Germany and ukp wheat for export from the United Kingdom and satisfies the definitions for any equivalent, comparable and similar types of wheat to these standards as defined in other territories.
